(19) United States
(12) Patent Application Publication
(10) Pub. No.: US 2025/0021051 A1
(43) Pub. Date: Jan. 16, 2025

(54) TIMEPIECE DIAL AND TIMEPIECE

(71) Applicant: SEIKO WATCH KABUSHIKI KAISHA (trading as SEIKO WATCH CORPORATION), Tokyo (JP)

(72) Inventors: Akiko ARAKI, Chiba (JP); Kaoru NAGATA, Chiba (JP); Yasunori HARA, Chiba (JP); Ayaka HARA, Chiba (JP)

(21) Appl. No.: 18/768,835

(22) Filed: Jul. 10, 2024

(30) Foreign Application Priority Data
Jul. 13, 2023 (JP) 2023-115472

(51) Int. Cl. G04B 19/10

(52) U.S. Cl. CPC G04B 19/10

(57) ABSTRACT

Provided is a timepiece dial and a timepiece. In a timepiece dial, a surface decoration including a plurality of protrusion portions is formed on a first main surface. In at least one of the protrusion portions, inclination angles of a first inclined surface that increases in height toward a vertex and a second inclined surface that decreases in height from the vertex are different in a first cross-section perpendicular to a first direction. In the first cross-section, two or more of the plurality of protrusion portions have different heights. There are two or more of the protrusion portions in a second cross-section perpendicular to a second direction perpendicular to the first direction along a first main surface.

### RELATED APPLICATIONS

This application claims priority to Japanese Patent application Nos. JP2023-115472, filed on Jul. 13, 2023, the entire content of which is incorporated herein by reference.

### BACKGROUND OF THE INVENTION

### 1. Field of the Invention

The present invention relates to a timepiece dial and a timepiece.

### 2. Description of the Related Art

An index indicating time, or the like is formed on a surface of a timepiece dial. An index is formed on a surface of a dial in a protrusion shape (for example, see JP2001-33568A and JPH02-189493A).

In addition to the index, a surface decoration due to unevenness may be formed on the dial to improve designability. However, in the surface decoration, a height of the unevenness may be restricted by a dimension in an outer case defined by a thickness of a product, manufacturing reasons, and the like. Therefore, in the dial, it is not easy to improve decorativeness of the surface decoration having large unevenness.

### SUMMARY OF THE INVENTION

It is an aspect of the present application to provide a timepiece dial and a timepiece capable of improving decorativeness of a surface decoration.
(1) A timepiece dial, in which a surface decoration including a plurality of protrusion portions is formed in a first main surface, in at least one of the protrusion portions, inclination angles of a first inclined surface that increases in height toward a vertex and a second inclined surface that decreases in height from the vertex are different in a first cross-section perpendicular to a first direction along the first main surface, in the first cross-section, two or more of the plurality of protrusion portions have different heights, and there are two or more of the protrusion portions in a second cross-section perpendicular to a second direction perpendicular to the first direction along the first main surface.

According to this configuration, since the inclination angles of the first inclined surface and the second inclined surface are different, it is possible to perform a design such that light easily hits one inclined surface of the two inclined surfaces, and light is less likely to hit the other inclined surface of the two inclined surfaces. Since brightnesses of the two inclined surfaces can be freely set, a contrast of the brightnesses of the two inclined surfaces can be increased. Therefore, it is possible to give the surface decoration a deep and luxurious appearance. Further, since a range of brightness that can be set for the two inclined surfaces is increased, a degree of freedom in design of the dial can be increased. Accordingly, it is possible to implement the dial provided with the surface decoration excellent in decorativeness.

According to the configuration, since the heights of the two or more protrusion portions are different, it is possible to mix a protrusion portion having a large area hit by light and a protrusion portion having a small area hit by light. Therefore, the surface decoration can be given a deep appearance that is not monotonous. Further, since the heights of the protrusion portions are not uniform, various expressions are possible. Accordingly, the degree of freedom in design of the dial can be improved. Accordingly, it is possible to implement the dial provided with the surface decoration excellent in decorativeness.

According to the configuration, since there are two or more protrusion portions not only on the first cross-section but also on the second cross-section, the protrusion portions implementing the surface decoration are formed at various positions in a plurality of directions. Accordingly, the surface decoration can be given a luxurious appearance that is not monotonous. Accordingly, it is possible to implement the dial provided with the surface decoration excellent in decorativeness.
(2) The timepiece dial according to (1), in which an inter-vertex distance between the protrusion portions adjacent in the first direction and an inter-vertex distance between the protrusion portions adjacent in the second direction are different.

According to this configuration, in a direction in which the inter-vertex distance is large, the visibility of a portion of the protrusion portion that is hit by light hardly changes even when a direction of the light hitting the dial is changed. Therefore, the influence caused by the surface decoration on the visibility of the index can be reduced. Accordingly, the visibility of the index is good even when the decorativeness is improved by forming the surface decoration having unevenness on the dial.
(3) The timepiece dial according to (1) or (2), in which the protrusion portion has a ridge line at least partially curved in a plan view.

According to this configuration, since the ridge line is at least partially curved, the protrusion portion can give a luxurious appearance that is not monotonous to the surface decoration.
(4) The timepiece dial according to any one of (1) to (3), in which the first main surface is covered with a transparent resin layer.

According to this configuration, it is possible to give the surface decoration a three-dimensional and deep visual effect.
(5) A timepiece includes: the timepiece dial according to any one of (1) to (4).

According to this configuration, it is possible to implement a timepiece including the dial including the surface decoration excellent in decorativeness.

According to the application, a timepiece dial and a timepiece capable of improving decorativeness of a surface decoration can be provided.

### BRIEF DESCRIPTION OF THE DRAWINGS

FIG. 1 is a cross-sectional view of a timepiece including a timepiece dial according to a first embodiment.

FIG. 2 is a plan view of the timepiece dial according to the first embodiment.

FIG. 3 is a cross-sectional view taken along a line I-I in FIG. 2.

FIG. 4 is a perspective view of a partial cross-sectional state of the timepiece dial according to the first embodiment.

FIG. 5 is a plan view of a partial region of the timepiece dial according to the first embodiment.

FIG. 6 is a view illustrating a height distribution in a II-II cross-section in FIG. 5.

FIG. 7 is an enlarged plan view of a region A in FIG. 5.

FIG. 8 is a view illustrating a height distribution in a III-III cross-section in FIG. 7.

FIG. 9 is a plan view of a partial region of the timepiece dial according to the first embodiment.

FIG. 10 is a view illustrating a height distribution in a IV-IV cross-section in FIG. 9.

FIG. 11 is a plan view of a partial region of the timepiece dial according to the first embodiment.

FIG. 12 is a view illustrating a height distribution in a V-V cross-section in FIG. 11.

FIG. 13 is a plan view of a partial region of the timepiece dial according to the first embodiment and is a view illustrating a height distribution.

FIG. 14 is a cross-sectional view of a timepiece dial according to a second embodiment.

FIG. 15 is a schematic view illustrating reflection of light in the timepiece dial according to the second embodiment.

FIG. 16 is a schematic view illustrating reflection of light in a timepiece dial according to another embodiment.

FIG. 17 is a cross-sectional view of a timepiece dial according to a first modification of the second embodiment.

FIG. 18 is a cross-sectional view of a timepiece dial according to a second modification of the second embodiment.

### DETAILED DESCRIPTION OF THE PREFERRED EMBODIMENTS

Hereinafter, embodiments of the invention will be described with reference to the drawings.

### Timepiece

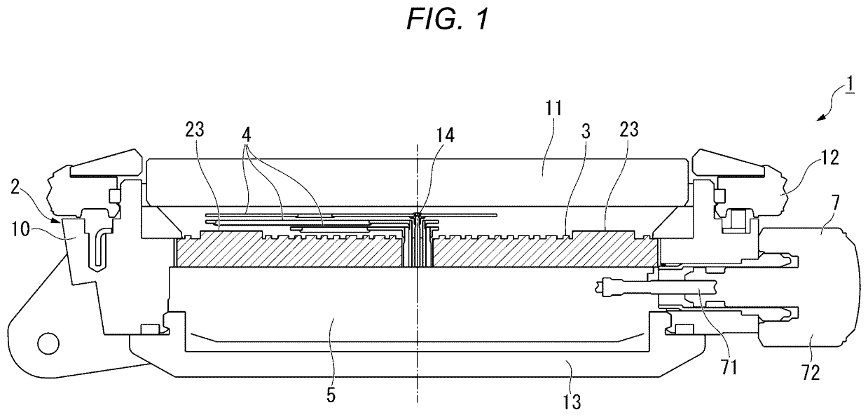

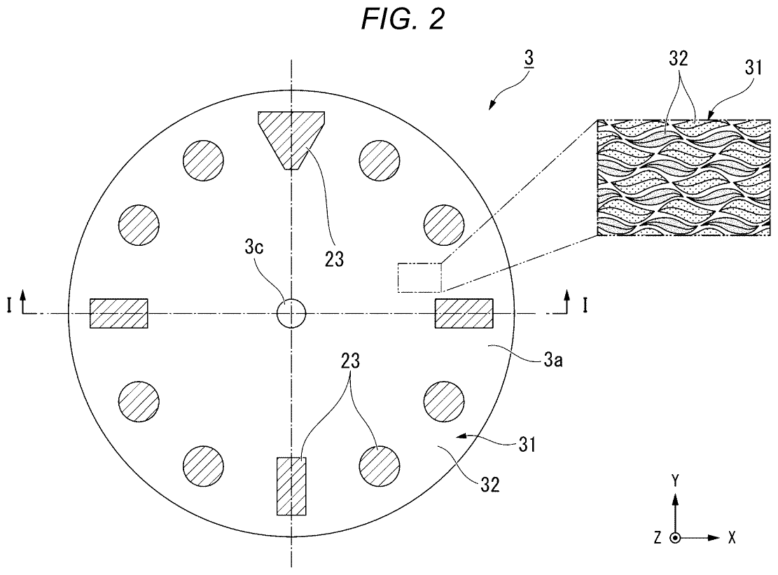

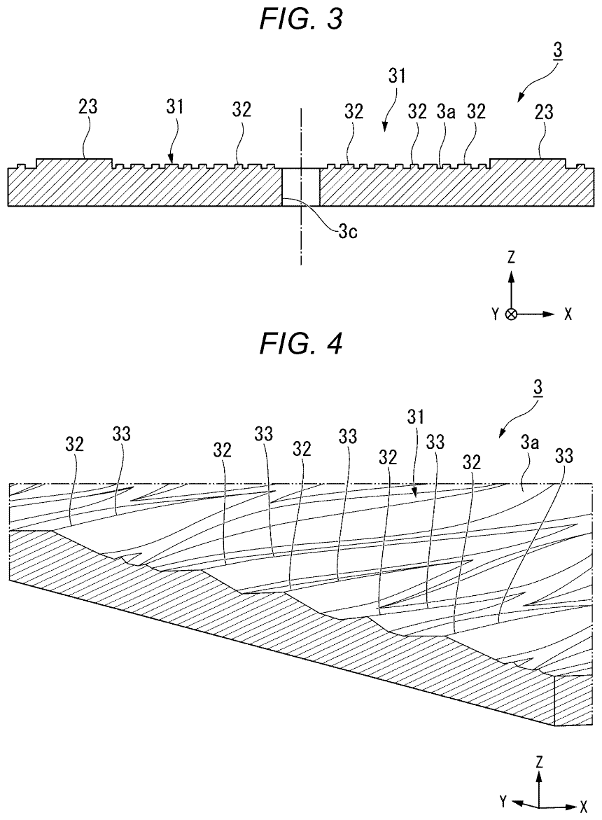

FIG. 1 is a cross-sectional view of a timepiece 1 including a dial 3 according to an embodiment. FIG. 2 is a plan view of the dial 3. FIG. 3 is a cross-sectional view of the dial 3. FIG. 3 is a cross-sectional view taken along a line I-I in FIG. 2.

As illustrated in FIG. 1, the timepiece 1 includes a timepiece case 2, the dial 3, hands 4, a movement 5 for timepiece, and a rotation operation unit 7.

The timepiece case 2 (case) includes a case main body 10, a glass 11, a bezel 12, and a case back 13. The case main body 10 is formed in a cylindrical shape. The glass 11 closes one opening of the case main body 10. The bezel 12 is provided at one opening end of the case main body 10. The case main body 10 holds the glass 11. The case back 13 closes the other opening of the case main body 10. The timepiece case 2 accommodates the dial 3, the hands 4, and the movement 5.

Hereinafter, positions and the like of components are temporarily determined with reference to FIG. 1. For example, the glass 11 is located above the case back 13. The positions and the like illustrated here do not limit postures of the timepiece 1 during use.

The hands 4 are disposed between the dial 3 and the glass 11. The hands 4 are attached to a rotation shaft 14 of the movement 5. The movement 5 is disposed between the dial 3 and the case back 13. The movement 5 includes a drive source that drives the rotation shaft 14, and the like. The rotation shaft 14 extends from a center of the dial 3 in a direction orthogonal to the dial 3.

The rotation operation unit 7 includes a rotation shaft portion 71 and a head portion 72. The rotation operation unit 7 (crown) causes rotation operations of components in the movement 5.

### Timepiece Dial First Embodiment

As illustrated in FIG. 2, the dial 3 (timepiece dial) is formed in a circular plate shape. The dial 3 is visible through the glass 11 (see FIG. 1). A view from a direction orthogonal to the dial 3 is referred to as a plan view.

The dial 3 is formed of, for example, one or two or more of a metal, ceramics, glass, and plastics. Examples of the metal forming the dial 3 include one or two or more of (A) copper, (B) iron, (C) titanium, (D) gold, (E) silver, (F) platinum, and G (nickel), or an alloy in which one or two or more of (A) to (G) are taken as main components. A “main component” is, for example, a component exceeding 50% by mass with respect to all the components. By using these materials, it is possible to facilitate processing of the dial 3 and to reduce costs.

A central hole 3c through which the rotation shaft 14 is inserted is formed at the center of the dial 3. The central hole 3c penetrates the dial 3 in a thickness direction.

A plurality of indexes 23 are formed in an upper surface 3a (first main surface) of the dial 3. The indexes 23 are, for example, displays that indicate time. The plurality of indexes 23 are formed, for example, at positions close to an outer peripheral edge of the dial 3 at intervals in a circumferential direction of the dial 3. The plurality of indexes 23 are formed, for example, at positions indicating 1 o'clock to 12 o'clock, respectively. The indexes 23 are formed integrally with the dial 3.

A shape of the index 23 is not particularly limited. The index 23 is in a shape of, for example, a figure, a character, or a symbol. In the plan view, the index 23 may be, for example, a bar shape along a radial direction of the dial 3, a circular shape, a polygonal shape (for example, a triangular shape, a rectangular shape, and a trapezoidal shape), and a number (Arabic numeral, Roman numeral, or the like) shape. The index 23 is also referred to as an hour mark.

As illustrated in FIG. 3, the index 23 is formed to protrude upward from the upper surface 3a of the dial 3.

A method of forming the index 23 is not particularly limited. The index 23 can be formed in a protrusion shape by pressing the dial 3. The index 23 can also be formed by cutting the surface of the dial 3 when the dial 3 is manufactured. When the dial 3 is formed of plastic or the like, the index 23 may be formed by a molding method such as injection molding. In addition, the index 23 can also be formed by electroforming or transfer.

A display layer containing a phosphorescence material may be formed on a surface of the index 23. The phosphorescence material absorbs energy when being stimulated by light, converts the absorbed energy into visible light, and emits light even after the stimulation stops. By adopting the display layer formed of the phosphorescence material, the index 23 can be easily visually recognized even in a dark place. When the display layer exhibits a color different from that of the dial 3, visibility of the display layer can be improved. The display layer may be formed of a fluorescent material. The display layer can be formed by printing, coating, or the like. The display layer may be separated from the index 23 and attached to the surface of the index 23.

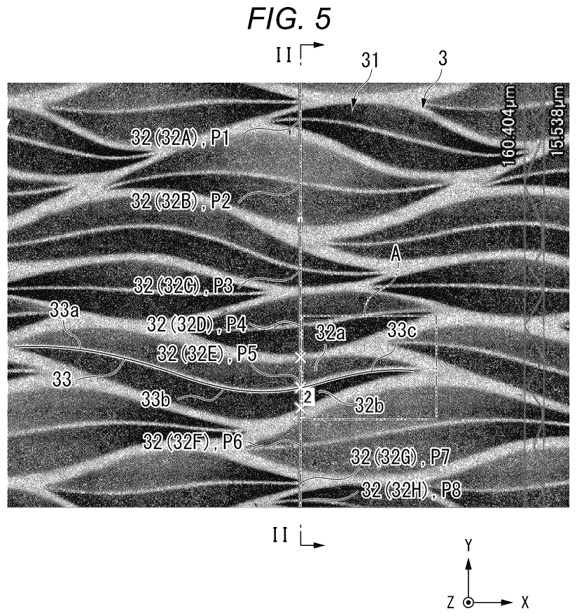

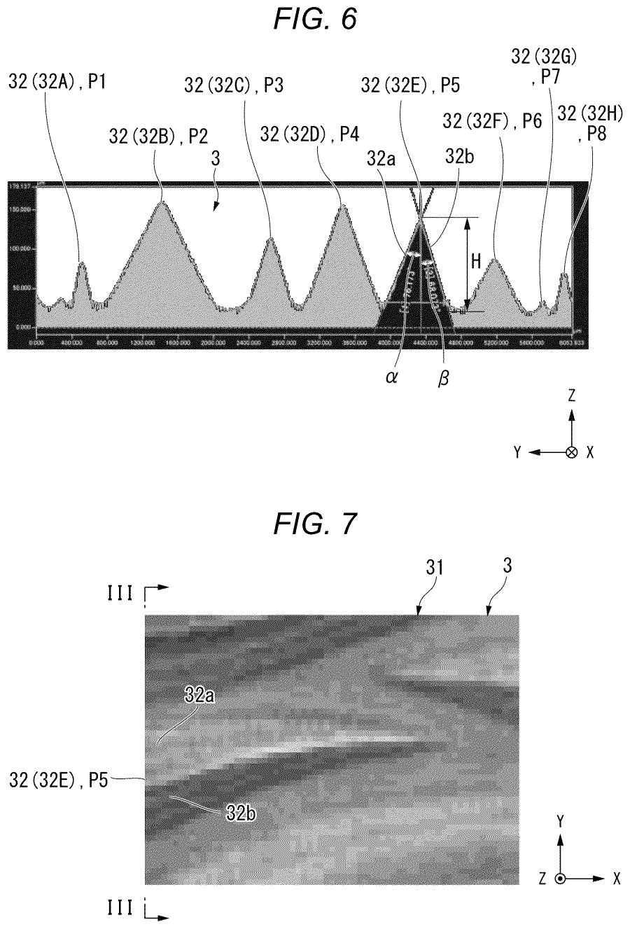

FIG. 4 is a perspective view of a partial cross-sectional state of the dial 3. FIG. 5 is a plan view of a partial region of the dial 3. A left-right direction (lateral direction) in FIG. 5 is an X direction (first direction). The X direction is a direction along the upper surface 3a and is a direction passing through the position at 3 o'clock and the position at 9 o'clock of the dial 3. An up-down direction (vertical direction) in FIG. 5 is a Y direction (second direction). The Y direction is a direction along the upper surface 3a and is a direction orthogonal to the X direction. The Y direction is a direction passing through the position at 6 o'clock and the position at 12 o'clock of the dial 3. A Z direction is a direction orthogonal to the X direction and the Y direction. A plane defined by the X direction and the Y direction is an XY plane. The Z direction is an up-down direction (height direction). FIG. 5 illustrates a rectangular region of 8 mm in width and 6 mm in length in the upper surface 3a. FIG. 6 is a view illustrating a height distribution in a II-II cross-section in FIG. 5. FIG. 6 illustrates a height distribution in a first cross-section perpendicular to the X direction.

An orientation from 9 o'clock to 3 o'clock along the X direction in the dial 3 is a +X orientation (see FIG. 2). An orientation opposite to the +X orientation is a −X orientation. An orientation from 6 o'clock to 12 o'clock along the Y direction is a +Y orientation (see FIG. 2). An orientation opposite to the +Y orientation is a −Y orientation.

As illustrated in FIG. 4, a surface decoration 31 is formed in the upper surface 3a (first main surface) of the dial 3 by unevenness. A shape of the surface decoration 31 is not particularly limited. The surface decoration 31 may be a pattern such as a wave pattern, a striped pattern, a lattice pattern, a polka-dot pattern, a wood-grain pattern, a stone-grain pattern, a geometric pattern, or a random pattern. The surface decoration 31 may indicate, for example, a figure designed from animals or plants. The surface decoration 31 can be formed by pressing, molding, cutting, or the like when the dial 3 is manufactured.

As illustrated in FIGS. 4 and 5, the surface decoration 31 includes a plurality of protrusion portions 32. The protrusion portions 32 extend in a predetermined direction. In the present embodiment, the surface decoration 31 includes a first protrusion portion 32A to an eighth protrusion portion 32H, which are the plurality of protrusion portions 32, on a line II-II in the region illustrated in FIG. 5. The first protrusion portion 32A to the eighth protrusion portion 32H are arranged in this order in the Y direction. For example, the first protrusion portion 32A to the eighth protrusion portion 32H are formed at intervals in the Y direction. The protrusion portion 32 satisfies the following conditions (1) to (3).

### (1) Height of Protrusion Portion in First Cross-Section

As illustrated in FIG. 6, in the first cross-section, two or more of the first protrusion portion 32A to the eighth protrusion portion 32H have different heights. For example, the first protrusion portion 32A to the eighth protrusion portion 32H have different heights. P1 to P8 are vertices of the first protrusion portion 32A to the eighth protrusion portion 32H, respectively. A height of the protrusion portion 32 is a height of a vertex with respect to a reference height position (for example, the lowest height position of the upper surface 3a in the region illustrated in FIG. 5) in the dial 3. For example, the height of the fifth protrusion portion 32E is a height H of the vertex P5 with respect to the reference height position.

### (2) Inclination Angle of Inclined Surface of at Least One Protrusion Portion in First Cross-Section

A shape of the protrusion portion 32 in the first cross-section is, for example, an inverted V shape having a first inclined surface 32a and a second inclined surface 32b. In at least one of the protrusion portions 32, the first inclined surface 32a and the second inclined surface 32b have different inclination angles in the first cross-section. In the present embodiment, at least the fifth protrusion portion 32E meets this condition. It is preferable that all of the first protrusion portion 32A to the eighth protrusion portion 32H correspond to “the first inclined surface 32a and the second inclined surface 32b have different inclination angles”. It is sufficient that at least one of the first protrusion portion 32A to the eighth protrusion portion 32H satisfies this condition.

The first inclined surface 32a of the fifth protrusion portion 32E gradually increases in height toward the vertex P5 in the −Y orientation. The second inclined surface 32b of the fifth protrusion portion 32E gradually decreases in height from the vertex P5 in the −Y orientation. The second inclined surface 32b is an inclined surface opposite to the first inclined surface 32a in the fifth protrusion portion 32E. The first inclined surface 32a and the second inclined surface 32b are inclined with respect to the XY plane.

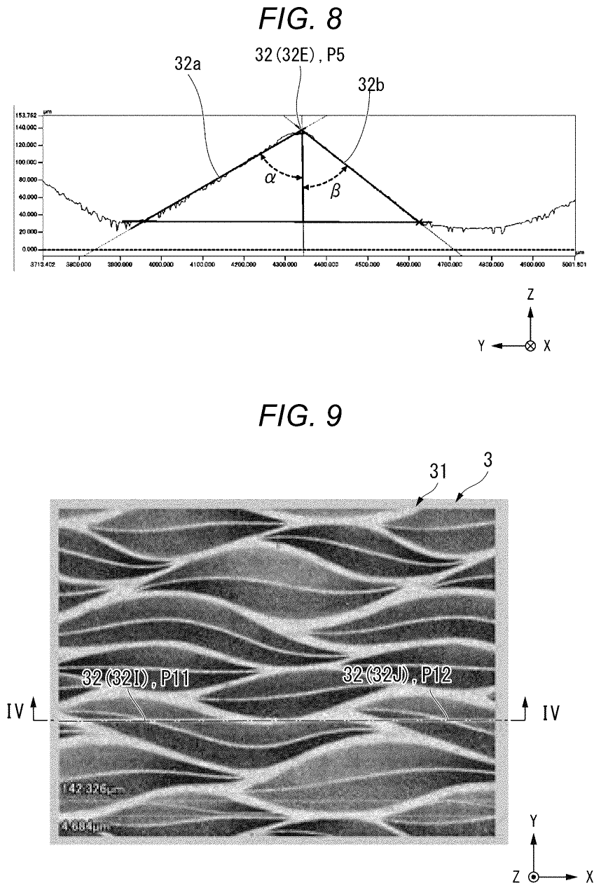

FIG. 7 is an enlarged plan view of a region A in FIG. 5. FIG. 8 is a view illustrating a height distribution in a III-III cross-section in FIG. 7.

As illustrated in FIG. 8, an inclination angle α of the first inclined surface 32a of the fifth protrusion portion 32E is larger than an inclination angle β of the second inclined surface 32b of the fifth protrusion portion 32E. The inclination angles α and β are angles with respect to the Z direction.

For example, the first inclined surface 32a and the second inclined surface 32b may have constant inclination angles over the entire height, or the inclination angles may not be constant. In the present embodiment, the first inclined surface 32a and the second inclined surface 32b have constant inclination angles over the entire height.

In the first cross-section, the first inclined surface 32a and the second inclined surface 32b may have a shape (curved recess shape) in which the inclination angle (angle with respect to the Z direction) decreases toward the vertex. In the first cross-section, the first inclined surface 32a and the second inclined surface 32b may have a shape (curved protrusion shape) in which the inclination angle (angle with respect to the Z direction) increases toward the vertex.

The inclination angle α of the first inclined surface 32a may be, for example, an angle (angle with respect to the Z direction) with respect to a tangent at the highest point of the first inclined surface 32a. The inclination angle β of the second inclined surface 32b may be, for example, an angle (angle with respect to the Z direction) with respect to a tangent at the highest point of the second inclined surface 32b. The inclination angles of the first inclined surface 32a and the second inclined surface 32b may be average inclination angles over the entire height.

The shape of the protrusion portion 32 in the first cross-section is not limited to the inverted V shape. The shape of the protrusion portion in the first cross-section may be a shape (trapezoidal shape) obtained by cutting a portion including a top portion from the protrusion portion having the inverted V shape. The protrusion portion having the trapezoidal shape has a shape having a top surface, and a first inclined surface and a second inclined surface extending obliquely downward from a peripheral edge of the top surface. The top surface is, for example, a flat surface along the XY plane. The plurality of protrusion portions may not have the same height. That is, two or more of the plurality of protrusion portions may have different heights.

### (3) The Number of Protrusion Portions in Second Cross-Section

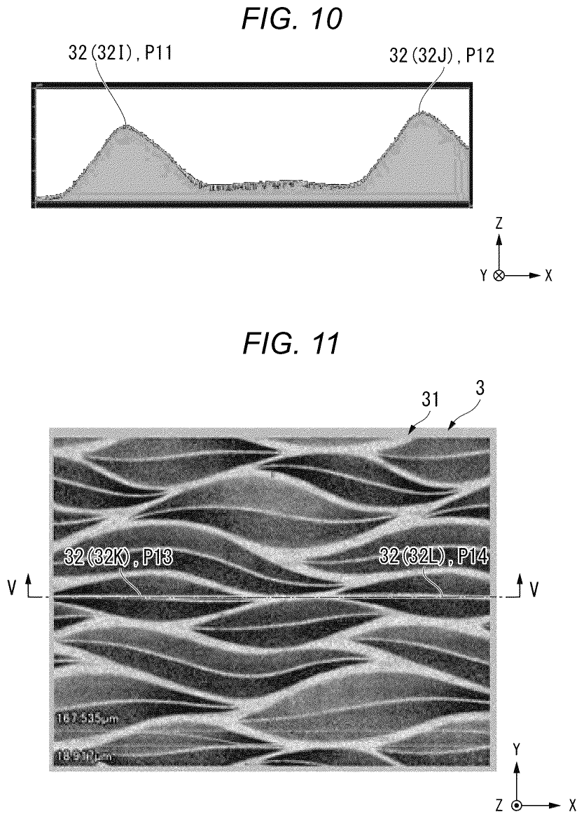

FIG. 9 is a plan view of a partial region of the dial 3. A left-right direction (lateral direction) in FIG. 9 is the X direction (first direction). An up-down direction (vertical direction) in FIG. 9 is the Y direction (second direction). FIG. 9 illustrates a rectangular region of 8 mm in width and 6 mm in length in the upper surface 3a. FIG. 10 is a view illustrating a height distribution in a IV-IV cross-section in FIG. 9. FIG. 10 illustrates a height distribution in a second cross-section perpendicular to the Y direction.

As illustrated in FIGS. 9 and 10, there are two or more protrusion portions 32 in the second cross-section. In the present embodiment, the surface decoration 31 includes a first protrusion portion 32I and a second protrusion portion 32J, which are the plurality of protrusion portions 32, on a line IV-IV in the region illustrated in FIG. 9. P11 and P12 are vertices of the first protrusion portion 32I and the second protrusion portion 32J, respectively. The first protrusion portion 32I and the second protrusion portion 32J are arranged in the X direction. For example, the first protrusion portion 32I and the second protrusion portion 32J are formed at an interval in the X direction. The number of the protrusion portions 32 may be three or more. In the present embodiment, the number of the protrusion portions 32 in the second cross-section is two or more in the partial region of the dial 3, and it is sufficient that the number of the protrusion portions 32 in the second cross-section is two or more over the entire length in the X direction.

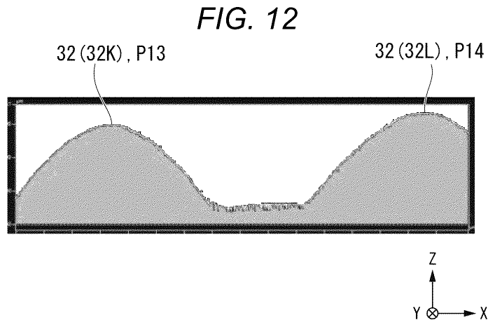

FIG. 11 is a plan view of a partial region of the dial 3. FIG. 11 is a plan view of the same region as that in FIG. 9. FIG. 12 is a view illustrating a height distribution in a V-V cross-section in FIG. 11. The V-V cross-section in FIG. 11 is a cross-section having a position in the Y direction different from that of the IV-IV cross-section in FIG. 9. FIG. 12 illustrates a height distribution in the second cross-section perpendicular to the Y direction.

As illustrated in FIGS. 11 and 12, there are two or more protrusion portions 32 in the second cross-section. In the present embodiment, the surface decoration 31 includes a third protrusion portion 32K and a fourth protrusion portion 32L, which are the plurality of protrusion portions 32, on a line V-V in the region illustrated in FIG. 11. P13 and P14 are vertices of the third protrusion portion 32K and the fourth protrusion portion 32L, respectively. The third protrusion portion 32K and the fourth protrusion portion 32L are arranged in the X direction. For example, the third protrusion portion 32K and the fourth protrusion portion 32L are formed at an interval in the X direction. The number of the protrusion portions 32 may be three or more. In the present embodiment, the number of the protrusion portions 32 in the second cross-section is two or more in the partial region of the dial 3, and it is sufficient that the number of the protrusion portions 32 in the second cross-section is two or more over the entire length in the X direction.

In the present embodiment, the surface decoration 31 has two or more protrusion portions 32 on two second cross-sections (the IV-IV cross-section in FIG. 9 and the V-V cross-section in FIG. 11), and in the surface decoration 31, the number of the protrusion portions 32 may be two or more on three or more second cross-sections.

It is preferable that the protrusion portion 32 satisfies the following conditions (4) and (5).

### (4) Relationship Between Inter-Vertex Distance of Adjacent Protrusion Portions in X Direction (First Direction) and Inter-Vertex Distance of Adjacent Protrusion Portions in Y Direction (Second Direction)

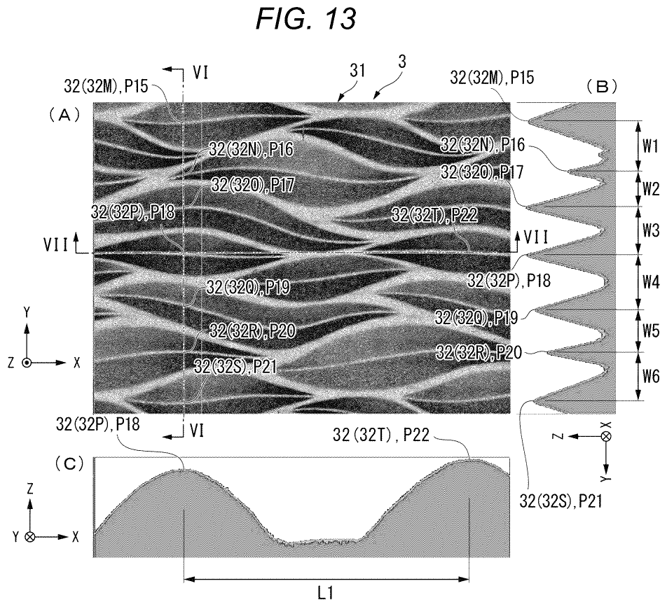

FIG. 13 is a plan view of a partial region of the dial 3 and is a view illustrating a height distribution. (A) of FIG. 13 is a plan view of a partial region of the dial 3. (B) of FIG. 13 is a view illustrating a height distribution in a VI-VI cross-section (first cross-section) in (A) of FIG. 13. (C) of FIG. 13 is a view illustrating a height distribution in a VII-VII cross-section (second cross-section) in (A) of FIG. 13.

As illustrated in (A) of FIG. 13, the surface decoration 31 includes a first protrusion portion 32M to a seventh protrusion portion 32S that are the plurality of protrusion portions 32 on a VI-VI line in the region illustrated in (A) of FIG. 13. P15 to P21 are vertices of the first protrusion portion 32M to the seventh protrusion portion 32S, respectively. The first protrusion portion 32M to the seventh protrusion portion 32S are arranged in this order in the Y direction. An inter-vertex distance of two adjacent protrusion portions 32 among the first protrusion portion 32M to the seventh protrusion portion 32S is referred to as a “first inter-vertex distance”. The first inter-vertex distance is an inter-vertex distance of two adjacent protrusion portions 32 in the Y direction (second direction).

As illustrated in (B) of FIG. 13, the first inter-vertex distance is, for example, an average value of inter-vertex distances W1 to W6. The inter-vertex distance W1 is an inter-vertex distance between the first protrusion portion 32M and the second protrusion portion 32N. The inter-vertex distance W2 is an inter-vertex distance between the second protrusion portion 32N and the third protrusion portion 32O. The inter-vertex distance W3 is an inter-vertex distance between the third protrusion portion 32O and the fourth protrusion portion 32P. The inter-vertex distance W4 is an inter-vertex distance between the fourth protrusion portion 32P and the fifth protrusion portion 32Q. The inter-vertex distance W5 is an inter-vertex distance between the fifth protrusion portion 32Q and the sixth protrusion portion 32R. The inter-vertex distance W6 is an inter-vertex distance between the sixth protrusion portion 32R and the seventh protrusion portion 32S.

As illustrated in (A) of FIG. 13, the surface decoration 31 includes the fourth protrusion portion 32P and an eighth protrusion portion 32T which are the plurality of protrusion portions 32 on a VII-VII line in the region illustrated in (A) of FIG. 13. P18 and P22 are vertices of the fourth protrusion portion 32P and the eighth protrusion portion 32T, respectively. The fourth protrusion portion 32P and the eighth protrusion portion 32T are arranged in the X direction. An inter-vertex distance between the fourth protrusion portion 32P and the eighth protrusion portion 32T is referred to as a “second inter-vertex distance”.

As illustrated in (C) of FIG. 13, the second inter-vertex distance is an inter-vertex distance L1 between two adjacent protrusion portions 32 in the X direction (first direction).

The number of the protrusion portions 32 may be three or more. In the present embodiment, since the number of the protrusion portions 32 is two, L1 is the second inter-vertex distance, and when the number of the protrusion portions 32 is three or more, the second inter-vertex distance is an average value of inter-vertex distances of adjacent protrusion portions 32.

The first inter-vertex distance (for example, the average value of W1 to W6 illustrated in (B) of FIG. 13) is different from the second inter-vertex distance (for example, L1 illustrated in (C) of FIG. 13). In the present embodiment, the second inter-vertex distance is larger than the first inter-vertex distance.

In the present embodiment, the second inter-vertex distance is larger than the first inter-vertex distance, and the first inter-vertex distance may be larger than the second inter-vertex distance.

### (5) Shape of Ridge Line of Protrusion Portion

As illustrated in FIG. 4, the protrusion portion 32 has a ridge line 33. The ridge line 33 is a boundary line between the first inclined surface 32a and the second inclined surface 32b of the protrusion portion 32. The ridge line 33 is a line obtained by connecting vertices in a plurality of cross-sections orthogonal to an extending direction of the protrusion portion 32. The ridge line 33 is formed over the entire length in the extending direction of the protrusion portion 32.

As illustrated in FIG. 5, the ridge line 33 is at least partially curved. The curved shape is, for example, an arc shape, an elliptic arc shape, or a high-order curved shape (parabolic shape, hyperbolic shape, or the like). The ridge line 33 has, for example, at least one curved portion. The curved portion has a curved shape. The ridge line 33 includes, for example, a first curved portion 33a, a second curved portion 33b, and a third curved portion 33c. The first curved portion 33a, the second curved portion 33b, and the third curved portion 33c are arranged in this order in a length direction of the protrusion portion 32. The first curved portion 33a is curved to protrude toward one side (+Y orientation). The second curved portion 33b is curved to protrude toward the other side (−Y orientation). The third curved portion 33c is curved to be protruded toward the one side (+Y orientation).

In the present embodiment, the protrusion portion 32 has the ridge line 33 at least partially curved, and a protrusion portion having a linear ridge line may be used.

The ridge line 33 may have a shape of a combination of one or a plurality of first curved portions and one or a plurality of second curved portions that are curved to be protruded toward the side opposite to that of the first curved portion.

The upper surface 3a of the dial 3 may be subjected to a surface treatment. The surface treatment can be formed by, for example, at least one of coating, printing, wet plating, and dry plating. Examples of the dry plating include physical vapor deposition (PVD) and chemical vapor deposition (CVD). With these surface treatments, the designability of the dial 3 can be improved.

### Effects of Dial According to Embodiment

In the dial 3 according to the present embodiment, the surface decoration 31 having the plurality of protrusion portions 32 is formed. The surface decoration 31 has the following configuration. (i) In at least one of the protrusion portions 32, the inclination angle α of the first inclined surface 32a and the inclination angle β of the second inclined surface 32b are different from each other in the first cross-section (see FIG. 8). (ii) In the first cross-section, two or more of the plurality of protrusion portions 32 have different heights (see FIG. 6). (iii) In the second cross-section, there are two or more protrusion portions 32 (see FIG. 10).

According to the configuration (i), it is possible to perform a design such that light easily hits one inclined surface of the two inclined surfaces 32a and 32b, and light is less likely to hit the other inclined surface of the inclined surfaces 32a and 32b. Since brightnesses of the two inclined surfaces 32a and 32b can be freely set, a contrast of the brightnesses of the two inclined surfaces 32a and 32b can be increased. Therefore, it is possible to give the surface decoration 31 a deep and luxurious appearance. Further, since a range of brightness that can be set for the two inclined surfaces 32a and 32b is increased, a degree of freedom in design of the dial 3 can be increased. Accordingly, it is possible to implement the dial 3 provided with the surface decoration 31 excellent in decorativeness.

According to the configuration (ii), since the heights of the two or more protrusion portions 32 are different, it is possible to mix the protrusion portion 32 having a large area hit by light and the protrusion portion 32 having a small area hit by light. Therefore, the surface decoration 31 can be given a deep appearance that is not monotonous. Further, since the heights of the protrusion portions 32 are not uniform, various expressions are possible. Accordingly, the degree of freedom in design of the dial 3 can be improved. Accordingly, it is possible to implement the dial 3 provided with the surface decoration 31 excellent in decorativeness.

According to the configuration (iii), since there are two or more protrusion portions 32 not only on the first cross-section but also on the second cross-section, the protrusion portions 32 implementing the surface decoration 31 are formed at various positions in a plurality of directions. Accordingly, the surface decoration 31 can be given a luxurious appearance that is not monotonous. Accordingly, it is possible to implement the dial 3 provided with the surface decoration 31 excellent in decorativeness.

In the dial 3, the inter-vertex distance between two adjacent protrusion portions 32 in the Y direction (second direction) (see (B) of FIG. 13) is different from the inter-vertex distance between two adjacent protrusion portions 32 in the X direction (first direction) (see (C) of FIG. 13). Therefore, in the Y direction (second direction) in which the inter-vertex distance is large, the visibility of a portion of the protrusion portion 32 that is hit by light hardly changes even when a direction of the light hitting the dial 3 is changed. Therefore, the influence caused by the surface decoration 31 on the visibility of the index 23 can be reduced. Accordingly, the visibility of the index 23 is good even when the decorativeness is improved by forming the surface decoration 31 having unevenness on the dial 3.

The protrusion portion 32 has the ridge line 33 at least partially curved in the plan view. Since the ridge line 33 is at least partially curved, the protrusion portion 32 can give a luxurious appearance that is not monotonous to the surface decoration 31.

The dial 3 can form the surface decoration 31 together with the index 23 by the pressing or the like. Since the number of manufacturing processes can be reduced, the dial 3 is excellent in mass productivity, ease of processing, and the like. Since the number of manufacturing processes can be reduced, the cost of the dial 3 can be reduced. The dial 3 may be manufactured by electroforming or transfer.

The timepiece 1 includes the dial 3. Therefore, as described above, the timepiece 1 including the dial 3 provided with the surface decoration 31 excellent in decorativeness can be implemented.

### Timepiece Dial Second Embodiment

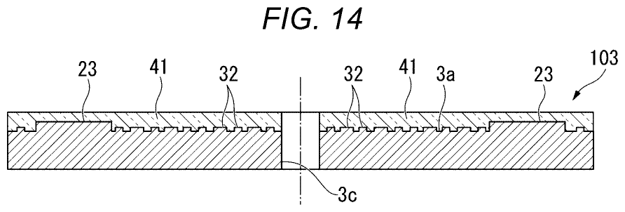

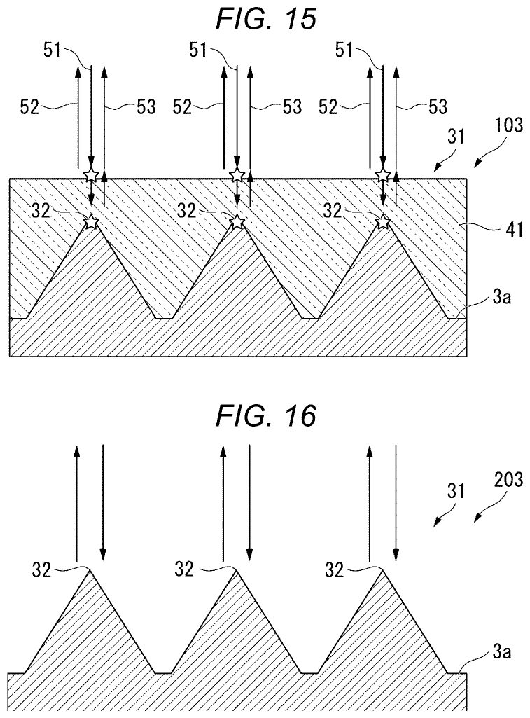

FIG. 14 is a partial cross-sectional view of a dial 103 according to a second embodiment. FIG. 15 is a schematic view illustrating reflection of light in the dial 103. Components common to those in the first embodiment are given the same reference numerals, and descriptions thereof will be omitted.

As illustrated in FIG. 14, in the dial 103, the upper surface 3a is covered with a transparent resin layer 41. The dial 103 has the same configuration as that of the dial 3 (see FIG. 3) according to the first embodiment except that the resin layer 41 is formed. The term “transparent” means, for example, that the transmittance (see JIS K7375: 2008) in a thickness direction of visible light is 50% or more in the entire wavelength range (380 nm to 780 nm) of the visible light.

The resin layer 41 protects the surface decoration 31 and also provides the surface decoration 31 with a three-dimensional and deep visual effect. The resin layer 41 is formed of, for example, a thermoplastic resin such as a polyolefin resin (polypropylene or the like), an ABS resin, or an acrylic resin. The resin layer 41 may be formed of a thermosetting resin such as a melamine resin, a phenol resin, a polyurethane resin, or an epoxy resin.

The resin layer 41 can be formed, for example, as follows. A resin is applied to the upper surface 3a of the dial 103 in an uncured state, and the resin is cured. Accordingly, the resin layer 41 is formed. A surface of the resin layer 41 is polished as necessary. With the polishing, surface unevenness of the resin layer 41 can be reduced, and gloss can be imparted to the resin layer 41.

### Effects of Dial According to Embodiment

The dial 103 according to the present embodiment has the following effects in addition to the same effects as those of the dial 3 according to the first embodiment.

As illustrated in FIG. 15, in the dial 103, the upper surface 3a is covered with the transparent resin layer 41. A part of emission light 51 emitted to the dial 103 is reflected by the surface of the resin layer 41 and becomes first reflected light 52. Another part of the emission light 51 passes through the surface of the resin layer 41, hits the surface decoration 31, is reflected by the surface of the surface decoration 31, and is emitted as second reflected light 53. Since a plurality piece of reflected light (first reflected light 52 and second reflected light 53) having different height positions of reflection points are emitted, it is possible to give the surface decoration 31 a three-dimensional and deep visual effect.

FIG. 16 is a partial cross-sectional view of a dial 203 according to another embodiment. FIG. 16 is a schematic view illustrating reflection of light in the dial 203.

As illustrated in FIG. 16, the dial 203 has the same configuration as that of the dial 103 (see FIG. 15) except that the resin layer 41 is not provided. In the dial 203, since there is no resin layer, two types of reflection do not occur. Therefore, a three-dimensional visual effect hardly occurs.

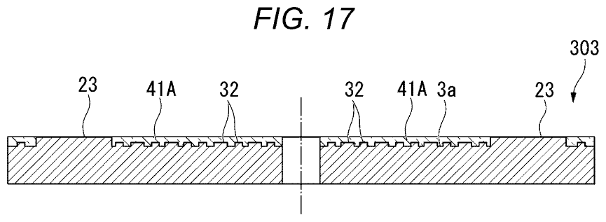

FIG. 17 is a cross-sectional view of a dial 303 according to a first modification of the second embodiment.

As illustrated in FIG. 17, in the dial 303, a resin layer 41A is formed in a region of the upper surface 3a excluding the indexes 23.

In the dial 303, since the resin layer 41A can be formed thin, the overall thickness can be reduced. In the dial 303, since the indexes 23 are not covered with the resin layer 41A, there is also an advantage that the indexes 23 can be easily visually recognized.

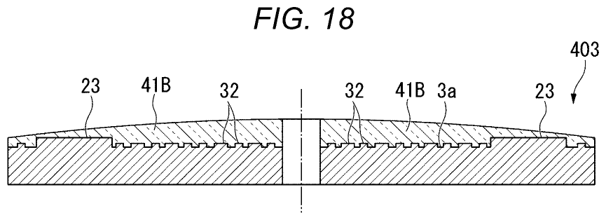

FIG. 18 is a cross-sectional view of a dial 403 according to a second modification of the second embodiment.

As illustrated in FIG. 18, in the dial 403, a resin layer 41B has a curve-shaped surface that protrudes upward.

Since the dial 403 includes the resin layer 41B having a curve-shaped surface, the visual effect can be improved.

The invention is not limited to the embodiments described above with reference to the drawings, and various modifications are conceivable within the technical scope of the invention. For example, although a lower surface of the dial 3 illustrated in FIG. 3 is flat, a recessed portion may be formed at a position corresponding to the index 23 on the lower surface of the dial 3.

What is claimed is:

1. A timepiece dial, wherein
a surface decoration including a plurality of protrusion portions is formed in a first main surface,
in at least one of the protrusion portions, inclination angles of a first inclined surface that increases in height toward a vertex and a second inclined surface that decreases in height from the vertex are different in a first cross-section perpendicular to a first direction along the first main surface,
in the first cross-section, two or more of the plurality of protrusion portions have different heights, and
there are two or more of the protrusion portions in a second cross-section perpendicular to a second direction perpendicular to the first direction along the first main surface.

2. The timepiece dial according to claim 1, wherein
an inter-vertex distance between the protrusion portions adjacent in the first direction and an inter-vertex distance between the protrusion portions adjacent in the second direction are different.

3. The timepiece dial according to claim 1, wherein
the protrusion portion has a ridge line at least partially curved in a plan view.

4. The timepiece dial according to claim 1, wherein
the first main surface is covered with a transparent resin layer.

5. A timepiece comprising:
the timepiece dial according to claim 1.
